(19) United States
(12) Patent Application Publication
(10) Pub. No.: US 2018/0167895 A1
(43) Pub. Date: Jun. 14, 2018

(54) METHOD FOR RECEIVING OR TRANSMITTING SOUNDING REFERENCE SIGNAL FOR POSITIONING IN WIRELESS COMMUNICATION SYSTEM AND APPARATUS THEREFOR

(71) Applicant: LG ELECTRONICS INC., Seoul (KR)

(72) Inventors: Hyunho LEE, Seoul (KR); Hanjun PARK, Seoul (KR); Kijun KIM, Seoul (KR)

(73) Assignee: LG ELECTRONICS INC., Seoul (KR)

(21) Appl. No.: 15/580,247

(22) PCT Filed: Jun. 2, 2016
(86) PCT No.: PCT/KR2016/005841

§ 371 Date: Dec. 6, 2017

Related U.S. Application Data
(60) Provisional application No. 62/172,198, filed on Jun. 7, 2015.
(60) Provisional application No. 62/206,295, filed on Aug. 18, 2015.

(51) Int. Cl. H04W 52/28; H04W 64/00; H04W 52/32; H04W 52/24

(52) U.S. Cl. CPC H04W 52/283; H04W 52/24; H04W 52/325; H04W 64/003

(57) ABSTRACT

A method for transmitting a sounding reference signal for positioning in a wireless communication system according to an embodiment of the present invention is performed by a terminal and comprises the steps of: receiving power control-related configuration information for the sounding reference signal; and transmitting the sounding reference signal using the power control related configuration information when a condition for use of the power control related configuration information is satisfied, wherein the power control related configuration information may indicate a transmission power control scheme or a transmission power value dedicated for the sounding reference signal for the positioning.

### TECHNICAL FIELD

The present invention relates to a wireless communication system, and more particularly, to a method of receiving or transmitting a sounding reference signal for positioning in a wireless communication system and an apparatus therefor.

### BACKGROUND ART

Recently, various devices requiring machine-to-machine (M2M) communication and high data transfer rate, such as smartphones or tablet personal computers (PCs), have appeared and come into widespread use. This has rapidly increased the quantity of data which needs to be processed in a cellular network. In order to satisfy such rapidly increasing data throughput, recently, carrier aggregation (CA) technology which efficiently uses more frequency bands, cognitive ratio technology, multiple antenna (MIMO) technology for increasing data capacity in a restricted frequency, multiple-base-station cooperative technology, etc. have been highlighted. In addition, communication environments have evolved such that the density of accessible nodes is increased in the vicinity of a user equipment (UE). Here, the node includes one or more antennas and refers to a fixed point capable of transmitting/receiving radio frequency (RF) signals to/from the user equipment (UE). A communication system including high-density nodes may provide a communication service of higher performance to the UE by cooperation between nodes.

A multi-node coordinated communication scheme in which a plurality of nodes communicates with a user equipment (UE) using the same time-frequency resources has much higher data throughput than legacy communication scheme in which each node operates as an independent base station (BS) to communicate with the UE without cooperation.

A multi-node system performs coordinated communication using a plurality of nodes, each of which operates as a base station or an access point, an antenna, an antenna group, a remote radio head (RRH), and a remote radio unit (RRU). Unlike the conventional centralized antenna system in which antennas are concentrated at a base station (BS), nodes are spaced apart from each other by a predetermined distance or more in the multi-node system. The nodes can be managed by one or more base stations or base station controllers which control operations of the nodes or schedule data transmitted/received through the nodes. Each node is connected to a base station or a base station controller which manages the node through a cable or a dedicated line.

The multi-node system can be considered as a kind of Multiple Input Multiple Output (MIMO) system since dispersed nodes can communicate with a single UE or multiple UEs by simultaneously transmitting/receiving different data streams. However, since the multi-node system transmits signals using the dispersed nodes, a transmission area covered by each antenna is reduced compared to antennas included in the conventional centralized antenna system. Accordingly, transmit power required for each antenna to transmit a signal in the multi-node system can be reduced compared to the conventional centralized antenna system using MIMO. In addition, a transmission distance between an antenna and a UE is reduced to decrease in pathloss and enable rapid data transmission in the multi-node system. This can improve transmission capacity and power efficiency of a cellular system and meet communication performance having relatively uniform quality regardless of UE locations in a cell. Further, the multi-node system reduces signal loss generated during transmission since base station(s) or base station controller(s) connected to a plurality of nodes transmit/receive data in cooperation with each other. When nodes spaced apart by over a predetermined distance perform coordinated communication with a UE, correlation and interference between antennas are reduced. Therefore, a high signal to interference-plus-noise ratio (SINR) can be obtained according to the multi-node coordinated communication scheme.

Owing to the above-mentioned advantages of the multi-node system, the multi-node system is used with or replaces the conventional centralized antenna system to become a new foundation of cellular communication in order to reduce base station cost and backhaul network maintenance cost while extending service coverage and improving channel capacity and SINR in next-generation mobile communication systems.

### DISCLOSURE OF THE INVENTION

### Technical Task

A technical task of the present invention is to provide a method of receiving or transmitting a reference signal for positioning in a wireless communication system and an operation related to the method.

Technical tasks obtainable from the present invention are non-limited the above-mentioned technical task. And, other unmentioned technical tasks can be clearly understood from the following description by those having ordinary skill in the technical field to which the present invention pertains.

### Technical Solution

To achieve these and other advantages and in accordance with the purpose of the present invention, as embodied and broadly described, according to one embodiment, a method of transmitting a sounding reference signal for positioning, which is transmitted by a terminal in a wireless communication system, includes the steps of receiving power control related configuration information on a sounding reference signal, and if a condition for using the power control related configuration information is satisfied, transmitting the sounding reference signal using the power control related configuration information. In this case, the power control related configuration information may indicate a sounding reference signal for the positioning-dedicated transmission power value or a transmission power control scheme.

Additionally or alternatively, the condition for using the power control related configuration information is satisfied when at least one of the followings occurs: when transmission of the sounding reference signal is triggered by a predetermined triggering type, when the sounding reference signal is transmitted in a predetermined time resource or a predetermined frequency resource, when a bit field indicating the predetermined triggering type corresponds to a predetermined bit value, and when a mode for a feedback of uplink (UL) control information only via a UL data channel is configured and a predetermined bit field belonging to information indicating transmission of the UL control information corresponds to a predetermined bit value.

Additionally or alternatively, if a plurality of cells or component carriers are configured for the terminal, a condition for using the power control related configuration information may be independently configured according to each cell or each component carrier of the configured plurality of cells or component carriers.

Additionally or alternatively, the sounding reference signal may be allocated to a UL resource using a resource allocation scheme dedicated to the sounding reference signal.

Additionally or alternatively, the resource allocation scheme may indicate allocation to the last N symbols in a subframe in which the sounding reference signal is transmitted or allocation to the last M symbols of each slot in the subframe in which the sounding reference signal is transmitted.

To further achieve these and other advantages and in accordance with the purpose of the present invention, according to a different embodiment, a terminal configured to transmit a sounding reference signal for positioning in a wireless communication system includes a radio frequency (RF) unit and a processor that controls the RF unit, wherein the processor controls the RF unit to receive power control related configuration information on a sounding reference signal, if a condition for using the power control related configuration information is satisfied, controls the RF unit to transmit the sounding reference signal using the power control related configuration information. In this case, the power control related configuration information may indicate a sounding reference signal-dedicated transmit power value or a transmit power control scheme for the positioning.

Additionally or alternatively, the condition for using the power control related configuration information is satisfied when at least one of the followings occurs: when transmission of the sounding reference signal is triggered by a predetermined triggering type, when the sounding reference signal is transmitted in a predetermined time resource or a predetermined frequency resource, when a bit field indicating the predetermined triggering type corresponds to a predetermined bit value, and when a mode for a feedback of uplink (UL) control information only via a UL data channel is configured and a predetermined bit field belonging to information indicating transmission of the UL control information corresponds to a predetermined bit value.

Additionally or alternatively, if a plurality of cells or component carriers are configured for the terminal, a condition for using the power control related configuration information may be independently configured according to each cell or each component carrier of the configured plurality of cells or component carriers.

Additionally or alternatively, the sounding reference signal may be allocated to a UL resource using a resource allocation scheme dedicated to the sounding reference signal.

Additionally or alternatively, the resource allocation scheme may indicate allocation to the last N symbols in a subframe in which the sounding reference signal is transmitted or allocation to the last M symbols of each slot in the subframe in which the sounding reference signal is transmitted.

To further achieve these and other advantages and in accordance with the purpose of the present invention, according to a further different embodiment, an eNB configured to transmit a pilot signal for determining a position in an unlicensed band in a wireless communication system includes an RF (radio frequency) unit and a processor configured to control the RF unit, the processor configured to transmit pilot signal related configuration information for determining a position which is transmitted in a period for which signal transmission is permitted without channel sensing in the unlicensed band, the processor configured to transmit a pilot signal for determining the position according to the pilot signal related configuration information for determining the position, the processor configured to receive a measurement result of the pilot signal for determining the position.

Technical solutions obtainable from the present invention are non-limited the above-mentioned technical solutions. And, other unmentioned technical solutions can be clearly understood from the following description by those having ordinary skill in the technical field to which the present invention pertains.

### Advantageous Effects

According to one embodiment of the present invention, it is able to efficiently receive or transmit a sounding reference signal for positioning and measure the sounding reference signal in a wireless communication system.

Effects obtainable from the present invention may be non-limited by the above mentioned effect. And, other unmentioned effects can be clearly understood from the following description by those having ordinary skill in the technical field to which the present invention pertains.

### DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a diagram for an example of a radio frame structure used in a wireless communication system;

FIG. 2 is a diagram for an example of a downlink (DL)/uplink (UL) slot structure in a wireless communication system;

FIG. 3 is a diagram for an example of a downlink (DL) subframe structure used in 3GPP LTE/LTE-A system;

FIG. 4 is a diagram for an example of an uplink (UL) subframe structure used in 3GPP LTE/LTE-A system;

FIG. 5 is a diagram for an SRS transmission resource;

FIG. 6 is a diagram illustrating an operation according to one embodiment of the present invention;

FIG. 7 is a block diagram of a device for implementing embodiment(s) of the present invention.

### BEST MODE

### Mode for Invention

Reference will now be made in detail to the preferred embodiments of the present invention, examples of which are illustrated in the accompanying drawings. The accompanying drawings illustrate exemplary embodiments of the present invention and provide a more detailed description of the present invention. However, the scope of the present invention should not be limited thereto.

In some cases, to prevent the concept of the present invention from being ambiguous, structures and apparatuses of the known art will be omitted, or will be shown in the form of a block diagram based on main functions of each structure and apparatus. Also, wherever possible, the same reference numbers will be used throughout the drawings and the specification to refer to the same or like parts.

In the present invention, a user equipment (UE) is fixed or mobile. The UE is a device that transmits and receives user data and/or control information by communicating with a base station (BS). The term ‘UE’ may be replaced with ‘terminal equipment’, ‘Mobile Station (MS)’, ‘Mobile Terminal (MT)’, ‘User Terminal (UT)’, ‘Subscriber Station (SS)’, ‘wireless device’, ‘Personal Digital Assistant (PDA)’, ‘wireless modem’, ‘handheld device’, etc. A BS is typically a fixed station that communicates with a UE and/or another BS. The BS exchanges data and control information with a UE and another BS. The term ‘BS’ may be replaced with ‘Advanced Base Station (ABS)’, ‘Node B’, ‘evolved-Node B (eNB)’, ‘Base Transceiver System (BTS)’, ‘Access Point (AP)’, ‘Processing Server (PS)’, etc. In the following description, BS is commonly called eNB.

In the present invention, a node refers to a fixed point capable of transmitting/receiving a radio signal to/from a UE by communication with the UE. Various eNBs can be used as nodes. For example, a node can be a BS, NB, eNB, pico-cell eNB (PeNB), home eNB (HeNB), relay, repeater, etc. Furthermore, a node may not be an eNB. For example, a node can be a radio remote head (RRH) or a radio remote unit (RRU). The RRH and RRU have power levels lower than that of the eNB. Since the RRH or RRU (referred to as RRH/RRU hereinafter) is connected to an eNB through a dedicated line such as an optical cable in general, cooperative communication according to RRH/RRU and eNB can be smoothly performed compared to cooperative communication according to eNBs connected through a wireless link. At least one antenna is installed per node. An antenna may refer to an antenna port, a virtual antenna or an antenna group. A node may also be called a point. Unlike a conventional centralized antenna system (CAS) (i.e. single node system) in which antennas are concentrated in an eNB and controlled an eNB controller, plural nodes are spaced apart at a predetermined distance or longer in a multi-node system. The plural nodes can be managed by one or more eNBs or eNB controllers that control operations of the nodes or schedule data to be transmitted/received through the nodes. Each node may be connected to an eNB or eNB controller managing the corresponding node via a cable or a dedicated line. In the multi-node system, the same cell identity (ID) or different cell IDs may be used for signal transmission/reception through plural nodes. When plural nodes have the same cell ID, each of the plural nodes operates as an antenna group of a cell. If nodes have different cell IDs in the multi-node system, the multi-node system can be regarded as a multi-cell (e.g., macro-cell/femto-cell/pico-cell) system. When multiple cells respectively configured by plural nodes are overlaid according to coverage, a network configured by multiple cells is called a multi-tier network. The cell ID of the RRH/RRU may be identical to or different from the cell ID of an eNB. When the RRH/RRU and eNB use different cell IDs, both the RRH/RRU and eNB operate as independent eNBs.

In a multi-node system according to the present invention, which will be described below, one or more eNBs or eNB controllers connected to plural nodes can control the plural nodes such that signals are simultaneously transmitted to or received from a UE through some or all nodes. While there is a difference between multi-node systems according to the nature of each node and implementation form of each node, multi-node systems are discriminated from single node systems (e.g. CAS, conventional MIMO systems, conventional relay systems, conventional repeater systems, etc.) since a plurality of nodes provides communication services to a UE in a predetermined time-frequency resource. Accordingly, embodiments of the present invention with respect to a method of performing coordinated data transmission using some or all nodes can be applied to various types of multi-node systems. For example, a node refers to an antenna group spaced apart from another node by a predetermined distance or more, in general. However, embodiments of the present invention, which will be described below, can even be applied to a case in which a node refers to an arbitrary antenna group irrespective of node interval. In the case of an eNB including an X-pole (cross polarized) antenna, for example, the embodiments of the preset invention are applicable on the assumption that the eNB controls a node composed of an H-pole antenna and a V-pole antenna.

A communication scheme through which signals are transmitted/received via plural transmit (Tx)/receive (Rx) nodes, signals are transmitted/received via at least one node selected from plural Tx/Rx nodes, or a node transmitting a downlink signal is discriminated from a node transmitting an uplink signal is called multi-eNB MIMO or CoMP (Coordinated Multi-Point Tx/Rx). Coordinated transmission schemes from among CoMP communication schemes can be categorized into JP (Joint Processing) and scheduling coordination. The former may be divided into JT (Joint Transmission)/JR (Joint Reception) and DPS (Dynamic Point Selection) and the latter may be divided into CS (Coordinated Scheduling) and CB (Coordinated Beamforming). DPS may be called DCS (Dynamic Cell Selection). When JP is performed, more various communication environments can be generated, compared to other CoMP schemes. JT refers to a communication scheme by which plural nodes transmit the same stream to a UE and JR refers to a communication scheme by which plural nodes receive the same stream from the UE. The UE/eNB combine signals received from the plural nodes to restore the stream. In the case of JT/JR, signal transmission reliability can be improved according to transmit diversity since the same stream is transmitted from/to plural nodes. DPS refers to a communication scheme by which a signal is transmitted/received through a node selected from plural nodes according to a specific rule. In the case of DPS, signal transmission reliability can be improved because a node having a good channel state between the node and a UE is selected as a communication node.

In the present invention, a cell refers to a specific geographical area in which one or more nodes provide communication services. Accordingly, communication with a specific cell may mean communication with an eNB or a node providing communication services to the specific cell. A downlink/uplink signal of a specific cell refers to a downlink/uplink signal from/to an eNB or a node providing communication services to the specific cell. A cell providing uplink/downlink communication services to a UE is called a serving cell. Furthermore, channel status/quality of a specific cell refers to channel status/quality of a channel or a communication link generated between an eNB or a node providing communication services to the specific cell and a UE. In 3GPP LTE-A systems, a UE can measure downlink channel state from a specific node using one or more CSI-RSs (Channel State Information Reference Signals) transmitted through antenna port(s) of the specific node on a CSI-RS resource allocated to the specific node. In general, neighboring nodes transmit CSI-RS resources on orthogonal CSI-RS resources. When CSI-RS resources are orthogonal, this means that the CSI-RS resources have different subframe configurations and/or CSI-RS sequences which specify subframes to which CSI-RSs are allocated according to CSI-RS resource configurations, subframe offsets and transmission periods, etc. which specify symbols and subcarriers carrying the CSI RSs.

In the present invention, PDCCH (Physical Downlink Control Channel)/PCFICH (Physical Control Format Indicator Channel)/PHICH (Physical Hybrid automatic repeat request Indicator Channel)/PDSCH (Physical Downlink Shared Channel) refer to a set of time-frequency resources or resource elements respectively carrying DCI (Downlink Control Information)/CFI (Control Format Indicator)/downlink ACK/NACK (Acknowledgement/Negative ACK)/downlink data. In addition, PUCCH (Physical Uplink Control Channel)/PUSCH (Physical Uplink Shared Channel)/PRACH (Physical Random Access Channel) refer to sets of time-frequency resources or resource elements respectively carrying UCI (Uplink Control Information)/uplink data/random access signals. In the present invention, a time-frequency resource or a resource element (RE), which is allocated to or belongs to PDCCH/PCFICH/PHICH/PDSCH/PUCCH/PUSCH/PRACH, is referred to as a PDCCH/PCFICH/PHICH/PDSCH/PUCCH/PUSCH/PRACH RE or PDCCH/PCFICH/PHICH/PDSCH/PUCCH/PUSCH/PRACH resource. In the following description, transmission of PUCCH/PUSCH/PRACH by a UE is equivalent to transmission of uplink control information/uplink data/random access signal through or on PUCCH/PUSCH/PRACH. Furthermore, transmission of PDCCH/PCFICH/PHICH/PDSCH by an eNB is equivalent to transmission of downlink data/control information through or on PDCCH/PCFICH/PHICH/PDSCH.

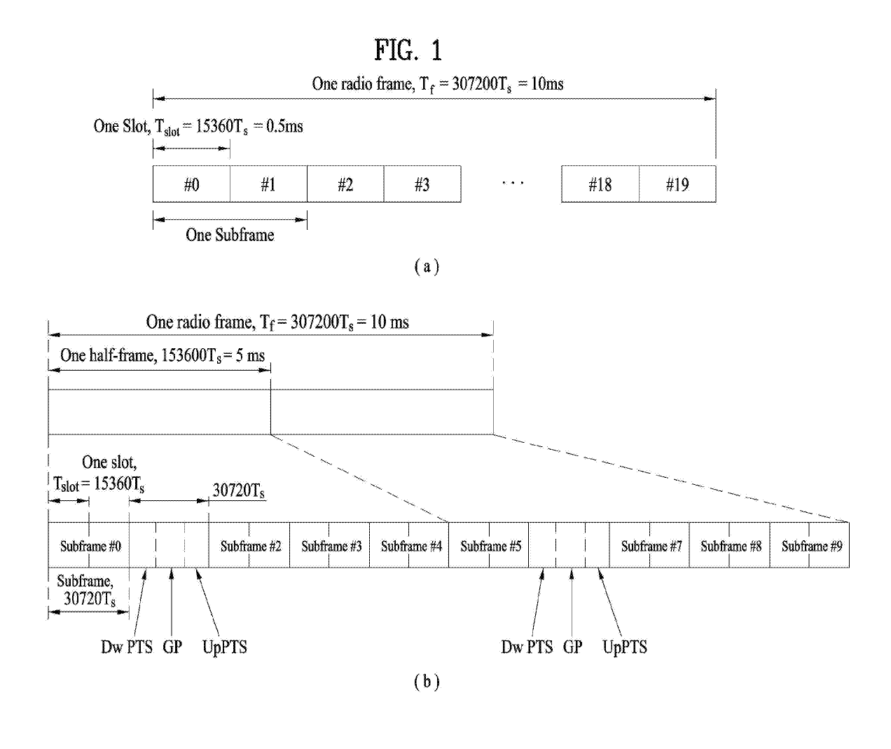

FIG. 1 illustrates an exemplary radio frame structure used in a wireless communication system. FIG. 1(a) illustrates a frame structure for frequency division duplex (FDD) used in 3GPP LTE/LTE-A and FIG. 1(b) illustrates a frame structure for time division duplex (TDD) used in 3GPP LTE/LTE-A.

Referring to FIG. 1, a radio frame used in 3GPP LTE/LTE-A has a length of 10 ms (307200 Ts) and includes 10 subframes in equal size. The 10 subframes in the radio frame may be numbered. Here, Ts denotes sampling time and is represented as Ts=1/(2048*15 kHz). Each subframe has a length of 1 ms and includes two slots. 20 slots in the radio frame can be sequentially numbered from 0 to 19. Each slot has a length of 0.5 ms. A time for transmitting a subframe is defined as a transmission time interval (TTI). Time resources can be discriminated by a radio frame number (or radio frame index), subframe number (or subframe index) and a slot number (or slot index).

The radio frame can be configured differently according to duplex mode. Downlink transmission is discriminated from uplink transmission by frequency in FDD mode, and thus the radio frame includes only one of a downlink subframe and an uplink subframe in a specific frequency band. In TDD mode, downlink transmission is discriminated from uplink transmission by time, and thus the radio frame includes both a downlink subframe and an uplink subframe in a specific frequency band.

Table 1 shows DL-UL configurations of subframes in a radio frame in the TDD mode.

TABLE 1

| | Downlink-to- | | | | | | | | | | |
|---|---|---|---|---|---|---|---|---|---|---|---|
| DL-UL | Uplink Switch- | | | | | | | | | | |
| config- | point | Subframe number | | | | | | | | | |
| uration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In Table 1, D denotes a downlink subframe, U denotes an uplink subframe and S denotes a special subframe. The special subframe includes three fields of DwPTS (Downlink Pilot TimeSlot), GP (Guard Period), and UpPTS (Uplink Pilot TimeSlot). DwPTS is a period reserved for downlink transmission and UpPTS is a period reserved for uplink transmission. Table 2 shows special subframe configuration.

TABLE 2

| | | | | Extended cyclic prefix in downlink | | |
|---|---|---|---|---|---|---|
| | Normal cyclic prefix in downlink | | | | UpPTS | |
| | | UpPTS | | | Normal | Extended |
| Special | | Normal | Extended | | cyclic | cyclic |
| subframe | | cyclic prefix | cyclic prefix | | prefix in | prefix in |
| configuration | DwPTS | in uplink | in uplink | DwPTS | uplink | uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | 12800 · Tₛ | | |
| 8 | 24144 · Tₛ | | | — | — | — |
| 9 | 13168 · Tₛ | | | — | — | — |

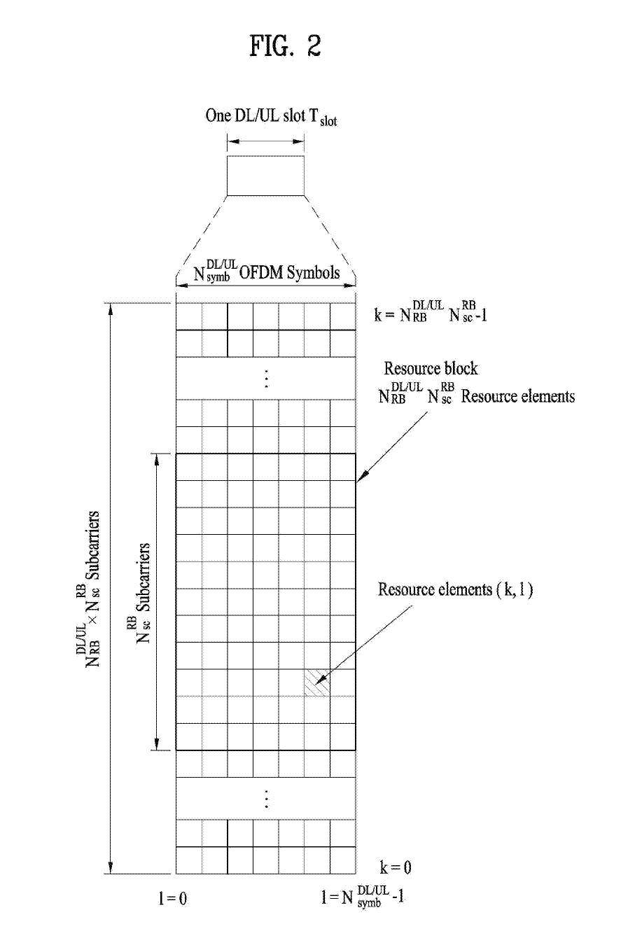

FIG. 2 illustrates an exemplary downlink/uplink slot structure in a wireless communication system. Particularly, FIG. 2 illustrates a resource grid structure in 3GPP LTE/LTE-A. A resource grid is present per antenna port.

Referring to FIG. 2, a slot includes a plurality of OFDM (Orthogonal Frequency Division Multiplexing) symbols in the time domain and a plurality of resource blocks (RBs) in the frequency domain. An OFDM symbol may refer to a symbol period. A signal transmitted in each slot may be represented by a resource grid composed of N_{RB}^{DL/UL}*N_{sc}^{RB} subcarriers and N_{symb}^{DL/UL} OFDM symbols. Here, N_{RB}^{DL} denotes the number of RBs in a downlink slot and N_{RB}^{UL} denotes the number of RBs in an uplink slot. N_{RB}^{DL} and N_{RB}^{UL} respectively depend on a DL transmission bandwidth and a UL transmission bandwidth. N_{symb}^{DL} denotes the number of OFDM symbols in the downlink slot and N_{symb}^{UL} denotes the number of OFDM symbols in the uplink slot. In addition, N_{sc}^{RB} denotes the number of subcarriers constructing one RB.

An OFDM symbol may be called an SC-FDM (Single Carrier Frequency Division Multiplexing) symbol according to multiple access scheme. The number of OFDM symbols included in a slot may depend on a channel bandwidth and the length of a cyclic prefix (CP). For example, a slot includes 7 OFDM symbols in the case of normal CP and 6 OFDM symbols in the case of extended CP. While FIG. 2 illustrates a subframe in which a slot includes 7 OFDM symbols for convenience, embodiments of the present invention can be equally applied to subframes having different numbers of OFDM symbols. Referring to FIG. 2, each 01-DM symbol includes N_{RB}^{DL/UL}*N_{sc}^{RB} subcarriers in the frequency domain. Subcarrier types can be classified into a data subcarrier for data transmission, a reference signal subcarrier for reference signal transmission, and null subcarriers for a guard band and a direct current (DC) component. The null subcarrier for a DC component is a subcarrier remaining unused and is mapped to a carrier frequency (f0) during OFDM signal generation or frequency up-conversion. The carrier frequency is also called a center frequency.

An RB is defined by N_{symb}^{DL/UL} (e.g., 7) consecutive OFDM symbols in the time domain and N_{sc}^{RB} (e.g., 12) consecutive subcarriers in the frequency domain. For reference, a resource composed by an OFDM symbol and a subcarrier is called a resource element (RE) or a tone. Accordingly, an RB is composed of N_{RB}^{DL/UL}*N_{sc}^{RB} REs. Each RE in a resource grid can be uniquely defined by an index pair (k, l) in a slot. Here, k is an index in the range of 0 to N_{RB}^{DL/UL}*N_{sc}^{RB}−1 in the frequency domain and l is an index in the range of 0 to N_{symb}^{DL/UL}−1.

Two RBs that occupy N_{sc}^{RB} consecutive subcarriers in a subframe and respectively disposed in two slots of the subframe are called a physical resource block (PRB) pair. Two RBs constituting a PRB pair have the same PRB number (or PRB index). A virtual resource block (VRB) is a logical resource allocation unit for resource allocation. The VRB has the same size as that of the PRB. The VRB may be divided into a localized VRB and a distributed VRB depending on a mapping scheme of VRB into PRB. The localized VRBs are mapped into the PRBs, whereby VRB number (VRB index) corresponds to PRB number. That is, nPRB=nVRB is obtained. Numbers are given to the localized VRBs from 0 to N_{VRB}^{DL}−1, and N_{VRB}^{DL}=N_{RB}^{DL} is obtained. Accordingly, according to the localized mapping scheme, the VRBs having the same VRB number are mapped into the PRBs having the same PRB number at the first slot and the second slot. On the other hand, the distributed VRBs are mapped into the PRBs through interleaving. Accordingly, the VRBs having the same VRB number may be mapped into the PRBs having different PRB numbers at the first slot and the second slot. Two PRBs, which are respectively located at two slots of the subframe and have the same VRB number, will be referred to as a pair of VRBs.

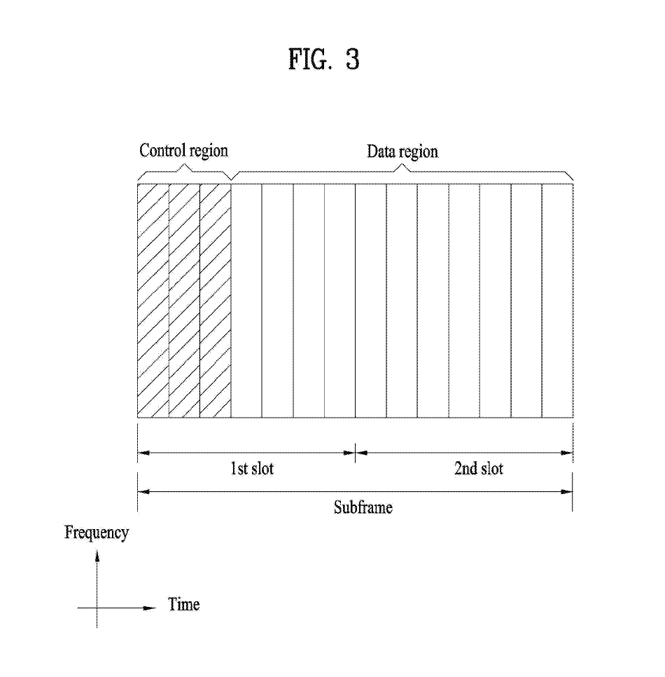

FIG. 3 illustrates a downlink (DL) subframe structure used in 3GPP LTE/LTE-A.

Referring to FIG. 3, a DL subframe is divided into a control region and a data region. A maximum of three (four) OFDM symbols located in a front portion of a first slot within a subframe correspond to the control region to which a control channel is allocated. A resource region available for PDCCH transmission in the DL subframe is referred to as a PDCCH region hereinafter. The remaining OFDM symbols correspond to the data region to which a physical downlink shared chancel (PDSCH) is allocated. A resource region available for PDSCH transmission in the DL subframe is referred to as a PDSCH region hereinafter. Examples of downlink control channels used in 3GPP LTE include a physical control format indicator channel (PCFICH), a physical downlink control channel (PDCCH), a physical hybrid ARQ indicator channel (PHICH), etc. The PCFICH is transmitted at a first OFDM symbol of a subframe and carries information regarding the number of OFDM symbols used for transmission of control channels within the subframe. The PHICH is a response of uplink transmission and carries an HARQ acknowledgment (ACK)/negative acknowledgment (NACK) signal.

Control information carried on the PDCCH is called downlink control information (DCI). The DCI contains resource allocation information and control information for a UE or a UE group. For example, the DCI includes a transport format and resource allocation information of a downlink shared channel (DL-SCH), a transport format and resource allocation information of an uplink shared channel (UL-SCH), paging information of a paging channel (PCH), system information on the DL-SCH, information about resource allocation of an upper layer control message such as a random access response transmitted on the PDSCH, a transmit control command set with respect to individual UEs in a UE group, a transmit power control command, information on activation of a voice over IP (VoIP), downlink assignment index (DAI), etc. The transport format and resource allocation information of the DL-SCH are also called DL scheduling information or a DL grant and the transport format and resource allocation information of the UL-SCH are also called UL scheduling information or a UL grant. The size and purpose of DCI carried on a PDCCH depend on DCI format and the size thereof may be varied according to coding rate. Various formats, for example, formats 0 and 4 for uplink and formats 1, 1A, 1B, 1C, 1D, 2, 2A, 2B, 2C, 3 and 3A for downlink, have been defined in 3GPP LTE. Control information such as a hopping flag, information on RB allocation, modulation coding scheme (MCS), redundancy version (RV), new data indicator (NDI), information on transmit power control (TPC), cyclic shift demodulation reference signal (DMRS), UL index, channel quality information (CQI) request, DL assignment index, HARQ process number, transmitted precoding matrix indicator (TPMI), precoding matrix indicator (PMI), etc. is selected and combined based on DCI format and transmitted to a UE as DCI.

In general, a DCI format for a UE depends on transmission mode (TM) set for the UE. In other words, only a DCI format corresponding to a specific TM can be used for a UE configured in the specific TM.

A PDCCH is transmitted on an aggregation of one or several consecutive control channel elements (CCEs). The CCE is a logical allocation unit used to provide the PDCCH with a coding rate based on a state of a radio channel. The CCE corresponds to a plurality of resource element groups (REGs). For example, a CCE corresponds to 9 REGs and an REG corresponds to 4 REs. 3GPP LTE defines a CCE set in which a PDCCH can be located for each UE. A CCE set from which a UE can detect a PDCCH thereof is called a PDCCH search space, simply, search space. An individual resource through which the PDCCH can be transmitted within the search space is called a PDCCH candidate. A set of PDCCH candidates to be monitored by the UE is defined as the search space. In 3GPP LTE/LTE-A, search spaces for DCI formats may have different sizes and include a dedicated search space and a common search space. The dedicated search space is a UE-specific search space and is configured for each UE. The common search space is configured for a plurality of UEs. Aggregation levels defining the search space is as follows.

TABLE 3

| Search Space | | | Number |
|---|---|---|---|
| | Aggregation | Size | of PDCCH |
| Type | Level L | [in CCEs] | candidates M^{(L)} |
| UE-specific | 1 | 6 | 6 |
| | 2 | 12 | 6 |
| | 4 | 8 | 2 |
| | 8 | 16 | 2 |
| Common | 4 | 16 | 4 |
| | 8 | 16 | 2 |

A PDCCH candidate corresponds to 1, 2, 4 or 8 CCEs according to CCE aggregation level. An eNB transmits a PDCCH (DCI) on an arbitrary PDCCH candidate with in a search space and a UE monitors the search space to detect the PDCCH (DCI). Here, monitoring refers to attempting to decode each PDCCH in the corresponding search space according to all monitored DCI formats. The UE can detect the PDCCH thereof by monitoring plural PDCCHs. Since the UE does not know the position in which the PDCCH thereof is transmitted, the UE attempts to decode all PDCCHs of the corresponding DCI format for each subframe until a PDCCH having the ID thereof is detected. This process is called blind detection (or blind decoding (BD)).

The eNB can transmit data for a UE or a UE group through the data region. Data transmitted through the data region may be called user data. For transmission of the user data, a physical downlink shared channel (PDSCH) may be allocated to the data region. A paging channel (PCH) and downlink-shared channel (DL-SCH) are transmitted through the PDSCH. The UE can read data transmitted through the PDSCH by decoding control information transmitted through a PDCCH. Information representing a UE or a UE group to which data on the PDSCH is transmitted, how the UE or UE group receives and decodes the PDSCH data, etc. is included in the PDCCH and transmitted. For example, if a specific PDCCH is CRC (cyclic redundancy check)-masked having radio network temporary identify (RNTI) of “A” and information about data transmitted using a radio resource (e.g., frequency position) of “B” and transmission format information (e.g., transport block size, modulation scheme, coding information, etc.) of “C” is transmitted through a specific DL subframe, the UE monitors PDCCHs using RNTI information and a UE having the RNTI of “A” detects a PDCCH and receives a PDSCH indicated by “B” and “C” using information about the PDCCH.

A reference signal (RS) to be compared with a data signal is necessary for the UE to demodulate a signal received from the eNB. A reference signal refers to a predetermined signal having a specific waveform, which is transmitted from the eNB to the UE or from the UE to the eNB and known to both the eNB and UE. The reference signal is also called a pilot. Reference signals are categorized into a cell-specific RS shared by all UEs in a cell and a modulation RS (DM RS) dedicated for a specific UE. A DM RS transmitted by the eNB for demodulation of downlink data for a specific UE is called a UE-specific RS. Both or one of DM RS and CRS may be transmitted on downlink. When only the DM RS is transmitted without CRS, an RS for channel measurement needs to be additionally provided because the DM RS transmitted using the same precoder as used for data can be used for demodulation only. For example, in 3GPP LTE(-A), CSI-RS corresponding to an additional RS for measurement is transmitted to the UE such that the UE can measure channel state information. CSI-RS is transmitted in each transmission period corresponding to a plurality of subframes based on the fact that channel state variation with time is not large, unlike CRS transmitted per subframe.

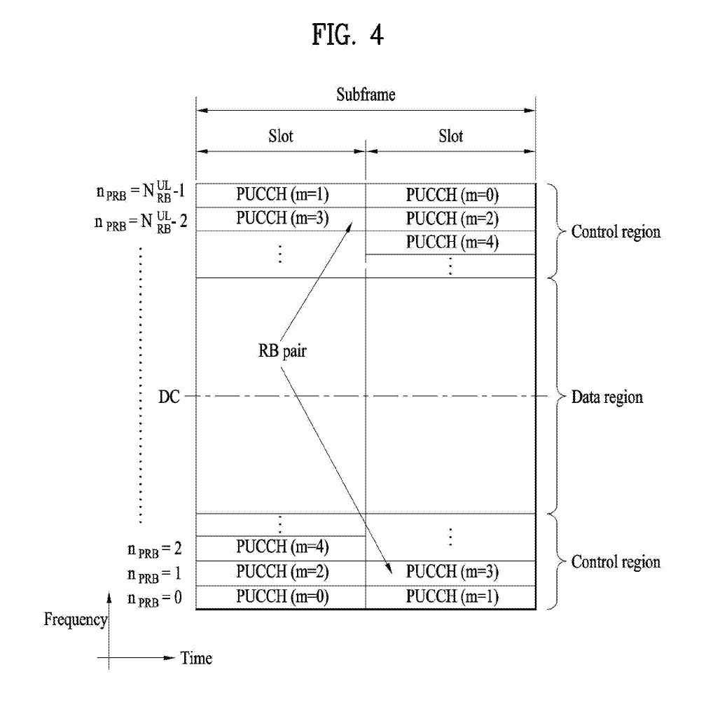

FIG. 4 illustrates an exemplary uplink subframe structure used in 3GPP LTE/LTE-A.

Referring to FIG. 4, a UL subframe can be divided into a control region and a data region in the frequency domain. One or more PUCCHs (physical uplink control channels) can be allocated to the control region to carry uplink control information (UCI). One or more PUSCHs (Physical uplink shared channels) may be allocated to the data region of the UL subframe to carry user data.

In the UL subframe, subcarriers spaced apart from a DC subcarrier are used as the control region. In other words, subcarriers corresponding to both ends of a UL transmission bandwidth are assigned to UCI transmission. The DC subcarrier is a component remaining unused for signal transmission and is mapped to the carrier frequency f0 during frequency up-conversion. A PUCCH for a UE is allocated to an RB pair belonging to resources operating at a carrier frequency and RBs belonging to the RB pair occupy different subcarriers in two slots. Assignment of the PUCCH in this manner is represented as frequency hopping of an RB pair allocated to the PUCCH at a slot boundary. When frequency hopping is not applied, the RB pair occupies the same subcarrier.

The PUCCH can be used to transmit the following control information.
Scheduling Request (SR): This is information used to request a UL-SCH resource and is transmitted using On-Off Keying (OOK) scheme.
HARQ ACK/NACK: This is a response signal to a downlink data packet on a PDSCH and indicates whether the downlink data packet has been successfully received. A 1-bit ACK/NACK signal is transmitted as a response to a single downlink codeword and a 2-bit ACK/NACK signal is transmitted as a response to two downlink codewords. HARQ-ACK responses include positive ACK (ACK), negative ACK (NACK), discontinuous transmission (DTX) and NACK/DTX. Here, the term HARQ-ACK is used interchangeably with the term HARQ ACK/NACK and ACK/NACK.
Channel State Indicator (CSI): This is feedback information about a downlink channel. Feedback information regarding MIMO includes a rank indicator (RI) and a precoding matrix indicator (PMI).

The quantity of control information (UCI) that a UE can transmit through a subframe depends on the number of SC-FDMA symbols available for control information transmission. The SC-FDMA symbols available for control information transmission correspond to SC-FDMA symbols other than SC-FDMA symbols of the subframe, which are used for reference signal transmission. In the case of a subframe in which a sounding reference signal (SRS) is configured, the last SC-FDMA symbol of the subframe is excluded from the SC-FDMA symbols available for control information transmission. A reference signal is used to detect coherence of the PUCCH. The PUCCH supports various formats according to information transmitted thereon.

Table 4 shows the mapping relationship between PUCCH formats and UCI in LTE/LTE-A.

TABLE 4

| | | Number | | |
|---|---|---|---|---|
| | | of bits per | | |
| PUCCH | Modulation | subframe, | | |
| format | scheme | M_{bit} | Usage | Etc. |
| 1 | N/A | N/A | SR (Scheduling | |
| | | | Request) | |
| 1a | BPSK | 1 | ACK/NACK or | One |
| | | | SR + ACK/NACK | codeword |
| 1b | QPSK | 2 | ACK/NACK or | Two |
| | | | SR + ACK/NACK | codeword |
| 2 | QPSK | 20 | CQI/PMI/RI | Joint coding |
| | | | | ACK/NACK |
| | | | | (extended |
| | | | | CP) |
| 2a | QPSK + | 21 | CQI/PMI/RI + | Normal CP |
| | BPSK | | ACK/NACK | only |
| 2b | QPSK + | 22 | CQI/PMI/RI + | Normal CP |
| | QPSK | | ACK/NACK | only |
| 3 | QPSK | 48 | ACK/NACK or | |
| | | | SR + ACK/NACK or | |
| | | | CQI/PMI/RI + | |
| | | | ACK/NACK | |

Referring to Table 4, PUCCH formats 1/1a/1b are used to transmit ACK/NACK information, PUCCH format 2/2a/2b are used to carry CSI such as CQI/PMI/RI and PUCCH format 3 is used to transmit ACK/NACK information.

In general, in order for a network obtain location information of a UE in a cellular communication system, various methods are used. In LTE system, a UE receives PRS (positioning reference signal) transmission related information from a higher layer signal and measures PRSs transmitted by cells near the UE to deliver an RSTD (reference signal time difference) corresponding to a difference between reception timing of a PRS transmitted by a reference eNB and reception timing of a PRS transmitted by a neighboring eNB to an eNB or a network. The network calculates a location of the UE by utilizing the RSTD and other information. The abovementioned positioning scheme utilizes OTDOA (observed time difference of arrival). Besides, other schemes such as A-GNSS (Assisted Global Navigation Satellite System) positioning scheme, E-CID (Enhanced Cell-ID) scheme, UTDOA (Uplink Time Difference of Arrival), and the like exist. The positioning schemes can be utilized for various location-based services (e.g., advertisement, location tracking, emergency communication means, etc.)

Meanwhile, although the aforementioned legacy positioning schemes are already supported by 3GPP UTRA and E-UTRA standard (e.g., LTE Rel-9), it is necessary to have an enhanced positioning scheme to have a higher accuracy for in-building positioning. In particular, although the legacy positioning schemes correspond to techniques capable of being commonly applied to outdoor/indoor environment, in case of E-CID scheme, a general positioning accuracy is known as 150 m and 50 m in NLOS environment and LOS environment, respectively. Moreover, the OTDOA scheme based on a PRS has such a critical point as a positioning error capable of exceeding 100 m due to an eNB synchronization error, an error generated by multipath propagation, an RSTD measurement quantization error of a UE, timing offset estimation error, and the like. In case of A-GNSS scheme, since the A-GNSS scheme requires a GNSS receiver, this scheme has a critical point in complexity and battery consumption. This scheme has a restriction on in-building positioning.

In the following, for clarity, a proposed scheme is explained based on 3GPP LTE system. Yet, a range of a system to which the proposed scheme is applied can be extended to a different system (e.g., UTRA, etc.) rather than the 3GPP LTE system.

The present invention basically considers a method of calculating location information of a UE. In particular, the location information of the UE can be calculated as follows. If the UE transmits a specific pilot signal (e.g., a specific reference signal), an eNB, a location measurement unit (LMU) (in the present specification, the LMU is used as a comprehensive terminology indicating all devices measuring the specific pilot signal), or a different UE measures the specific pilot signal, calculates a positioning-related estimation value using a specific positioning scheme, and reports the value to a network. A name of an eNB described in the present specification is used as a comprehensive term including an RRH (remote radio header), an eNB, a TP (transmission point), an RP (reception point), a relay, and the like.

Power Control of Reference Signal or Pilot Signal

An eNB, an LMU, or a location server (e.g., E-SMLC (enhanced serving mobile location center), SLP (SUPL location platforms), etc.) can configure all or a part of information described in the following to make a UE transmit a specific pilot signal, i.e., UL signal, for the purpose of positioning.
Transmission resource information (frequency/time resource, subframe-related information, transmission period and/or offset, etc.) of UL signal
Transmit power information of UL signal
Spatial domain information (antenna port, etc.) of UL signal

Meanwhile, a wireless communication system such as 3GPP LTE supports SRS (sounding reference signal) transmission of a UE to estimate UL channel quality for the purpose of link adaptation and the like in UL. For example, a UE can transmit a type 0 SRS (periodic SRS) triggered by higher layer signaling and a type 1 SRS (aperiodic SRS) triggered by DCI (downlink control information) in an SRS subframe predetermined by an eNB in LTE system.

In this case, an SRS subframe in which the type 0 SRS is transmitted and an SRS subframe in which the type 1 SRS is transmitted can be independently configured. A time axis position at which an SRS is transmitted in the SRS subframe corresponds to the last SC-FDMA symbol and an SRS is transmitted with a UE-specific SRS bandwidth configured by UE-dedicated RRC (radio resource control) signaling and a frequency offset in a cell-specific SRS bandwidth indicated by SIB2 (system information block 2) in a frequency axis position.

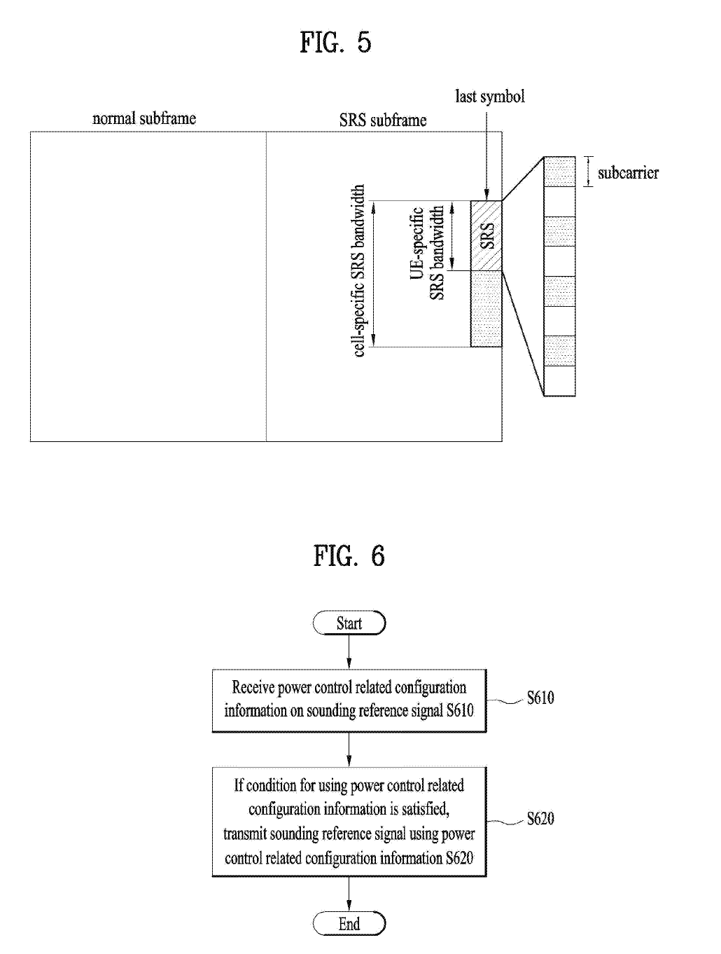

FIG. 5 illustrates an example of transmitting an SRS in a subframe consisting of 14 SC-FDMA symbols in normal CP environment.

When a UE transmits an SRS and such a device as an eNB or an LMU or a different terminal measures the SRS, if it is able to measure not only timing but also strength/power of a reception signal or quality (e.g., RSSI (received signal strength indicator), RSRP (reference signal received power), RSRQ (reference signal received quality), SINR (signal-to-interference-plus-noise ratio), etc.), it may be able to more precisely perform positioning of the UE.

When a UE transmits a signal, it may perform power control to more easily manage interference. Yet, when the power control is performed, the power control may be inappropriate for measuring strength/power or quality (e.g., RSSI, RSRP, RSRQ, SINR, etc.) of the signal. For example, when an eNB, an LMU, or a different terminal performs RSRP measurement on an SRS to perform positioning on two UEs located at a cell center and a cell edge, if an SRS on which power control is performed is transmitted by the two UEs, it is apparent that reliability of the RSRP measurement for performing positioning is reduced. Hence, the present invention proposes a method of setting independent power different from legacy power to an SRS transmitted by a UE (for performing positioning) to help the eNB, the LMU, or the different terminal to perform specific measurement (e.g., measurement for performing positioning).

In other word, if a specific situation/configuration is satisfied, a UE may transmit an SRS using power of a predefined/predetermined value without performing power control or transmit an SRS by configuring SRS power according to a power control scheme different from a legacy SRS power control scheme. In this case, a value corresponding to SRS transmit power can be configured via higher layer signaling (or physical layer signaling) in advance.

It may set independent power control different from legacy power control to SRS transmission according to an SRS triggering type of a UE. For example, it may transmit an SRS using predefined power without performing power control on a type 1 SRS only. Or, it may be able to configure an SRS to be transmitted by setting SRS power according to a power control scheme different from a legacy SRS power control scheme.

Or, it may set independent power control different from legacy power control to a specific SRS transmission resource only. For example, it may transmit an SRS using predefined SRS power without performing power control on a specific time (period)/frequency resource region only. Or, it may be able to configure an SRS to be transmitted by setting SRS power according to a power control scheme different from a legacy SRS power control scheme. In this case, the specific time (period)/frequency resource region can be indicated via higher layer signaling or physical layer signaling or can be defined in advance.

Or, it may transmit an SRS using predefined SRS power without performing power control on a prescribed time period. Or, it may be able to promise/configure an SRS to be transmitted by setting SRS power according to a power control scheme different from a legacy SRS power control scheme. If an SRS transmission subframe indicated by higher layer signaling (or physical layer signaling) is included in all or a part of a predetermined time period, it may transmit an SRS using predefined SRS power without performing power control on the SRS or it may configure an SRS to be transmitted by setting SRS power according to a power control scheme different from a legacy SRS power control scheme. Or, if an SRS transmission subframe is included in a predetermined specific subframe set, it may transmit an SRS using predefined power or it may configure an SRS to be transmitted by setting SRS power according to a power control scheme different from a legacy SRS power control scheme.

Or, it may transmit an SRS using predefined power without performing power control on the SRS for a prescribed frequency region or it may configure an SRS to be transmitted by setting SRS power according to a power control scheme different from a legacy SRS power control scheme. If an SRS transmission resource region indicated by higher layer signaling (or physical layer signaling) is included in all or a part of a predetermined frequency region, it may transmit an SRS using predefined SRS power without performing power control on the SRS or it may configure an SRS to be transmitted by setting SRS power according to a power control scheme different from a legacy SRS power control scheme.

And, it may differently configure whether or not power control is performed on an SRS according to a status corresponding to a bit of an SRS request field. For example, if the bit of the SRS request field corresponds to “11”, it may transmit an SRS using predefined SRS power without performing power control on the SRS or it may configure an SRS to be transmitted by setting SRS power according to a power control scheme different from a legacy SRS power control scheme.

And, if PUSCH feedback transmitting UCI only (“UCI only PUSCH feedback”) is configured, it may be able to configure power control of an SRS to be independent power control different from legacy power control using an NDI (new data indicator) field belonging to UL grant DCI. For example, if the UCI only PUSCH feedback is configured and the NDI corresponds to 0, the legacy SRS power control is applied. If the NDI corresponds to 1, it may transmit an SRS using predefined SRS power without performing power control on the SRS or it may configure an SRS to be transmitted by setting SRS power according to a power control scheme different from a legacy SRS power control scheme.

Meanwhile, although the SRS power control restricted by various situations/conditions has been explained in the foregoing description, the SRS power control can also be configured by an independent power control method different from a legacy power control method using a combination of partial situations/conditions rather than an independent situation/condition.

If it is able to perform CA on a plurality of cells/CCs (component carriers), power control can be independently and differently configured according to a cell/CC using the situations/conditions or a combination thereof. If it is necessary to perform power scaling on an SRS due to the CA operation and SRS transmission is triggered under the various situations/conditions or a combination thereof, a UE may not perform the power scaling on the SRS or apply a power scaling factor using a value promised with an eNB in advance.

And, power control can be independently defined using the aforementioned various situations/conditions or a combination thereof not only for the SRS but also for a legacy different RS or a newly defined RS for performing positioning (e.g., transmit power of an RS for performing positioning is configured by a predefined value).

RE Mapping

An SRS can be transmitted in the last SC-FDMA symbol only in a subframe in which the SRS is transmitted. The present invention proposes to set a rule different from a legacy rule to the subframe in which the SRS is transmitted to support specific measurement (e.g., measurement for positioning) in an eNB, an LMU, or a different terminal. In particular, it may be able to configure the SRS to be transmitted in all or a part of SC-FDMA symbols rather than the last SC-FDMA symbol of the subframe in which the SRS is transmitted. For example, RE mapping described in the following can be set to a UE.

(1) An SRS is transmitted in the last N number of SC-FDMA symbols of a subframe in which the SRS is transmitted.

(2) An SRS is transmitted in the last M number of SC-FDMA symbols of each slot of a subframe in which the SRS is transmitted.

Similarly, it may be able to set a rule different from a legacy rule to a frequency on which an SRS is transmitted and the SRS can be transmitted according to the rule.

Hence, it may be able to newly configure a different physical channel, whether or not a reference signal is transmitted, and a dropping prioritization rule. For example, if a subframe in which an SRS is transmitted is included in a predetermined specific subframe set, it may guarantee SRS transmission or set priority of the SRS transmission to be higher than legacy priority without following a legacy dropping prioritization rule.

Or, it may guarantee SRS transmission or set priority of the SRS transmission to be higher than legacy priority without following a legacy dropping prioritization rule for SRS transmission to which the aforementioned power control is applied only.

And, it may be able to configure independent RE mapping different from legacy RE mapping to be applied to SRS transmission according to an SRS triggering type of a UE. For example, in case of a type 1 SRS (i.e., aperiodic SRS), it may be able to configure independent RE mapping different from legacy RE mapping to be applied to SRS transmission.

And, it may be able to configure independent RE mapping different from legacy RE mapping to be applied to SRS transmission for a specific SRS transmission resource only. For example, when an SRS is configured to be transmitted in a predetermined or indicated specific subframe or a frequency region, it may be able to configure independent RE mapping different from legacy RE mapping to be applied to the subframe or the frequency region. Or, if a subframe in which an SRS is transmitted is included in a predetermined specific subframe set, it may be able to configure independent RE mapping different from legacy RE mapping to be applied to the specific subframe set.

And, it may be able to configure independent RE mapping different from legacy RE mapping to be applied to an SRS according to a status corresponding to a bit value of an SRS request field. For example, if the bit value of the SRS request field corresponds to “11”, it may be able to configure independent RE mapping different from legacy RE mapping to be applied to SRS transmission corresponding to the bit value of the SRS request field.

And, if UCI only PUSCH feedback is configured, it may be able to configure independent RE mapping different from legacy RE mapping to be applied using an NDI field belonging to UL grant DCI.

Measurement

It may be able to configure or indicate an eNB or an LMU to perform measurement related to power such as RSRP and RSRQ or signal quality (or a different metric similar to the power or the signal quality) on an RS to which the aforementioned power control and/or the RE mapping is applied and report a measurement result to a location server via higher layer signaling or physical layer signaling.

And, it may be able to configure or indicate a different UE to perform measurement related to power such as RSRP and RSRQ or signal quality (or a different metric similar to the power or the signal quality) on an RS to which the aforementioned power control and/or the RE mapping is applied and report a measurement result to a location server via higher layer signaling or physical layer signaling. The measurement operation performed by the different UE indicates that a UE is also able to measure an SRS transmitted by the different UE and use a measurement result for positioning in relation to D2D (device-to-device) or V2X (vehicle-to-everything).

Necessary Signaling

In order to support the aforementioned proposals, it may be necessary to exchange information between an eNB/LMU and a location server (e.g., E-SMLC, SLP, etc.). Specifically, the eNB/LMU may signal information on whether specific measurement is performed on an RS to which a legacy power control scheme is applied or an RS to which a new power control scheme (i.e., an independent power control scheme different from the legacy power control scheme) is applied to the location server.

And, the eNB/LMU may signal Pcmax corresponding to an SRS transmitted by a UE, a power headroom report, an accumulated TPC command, and the like to the location server irrespective of whether or not the proposed power control is applied.

And, the location server can signal information on whether the UE transmits the RS to which the legacy power control scheme is applied or the RS to which the new power control scheme (independent power control scheme different from the legacy power control scheme) is applied to the UE (or eNB/LMU).

And, the eNB/LMU can signal information on whether the UE transmits the RS to which the legacy power control scheme is applied or the RS to which the new power control scheme (independent power control scheme different from the legacy power control scheme) is applied to the location server (or the UE).

And, the location server can signal all or a part of information among transmit power or Pcmax corresponding to an SRS to which the new power control scheme (independent power control scheme different from the legacy power control scheme) is applied, a power headroom report, an accumulated TPC command to the UE (or the eNB/LMU).

And, the eNB/LMU can signal all or a part of information among transmit power or Pcmax corresponding to an SRS to which the new power control scheme (independent power control scheme different from the legacy power control scheme) is applied, a power headroom report, an accumulated TPC command to the location server (or the UE).

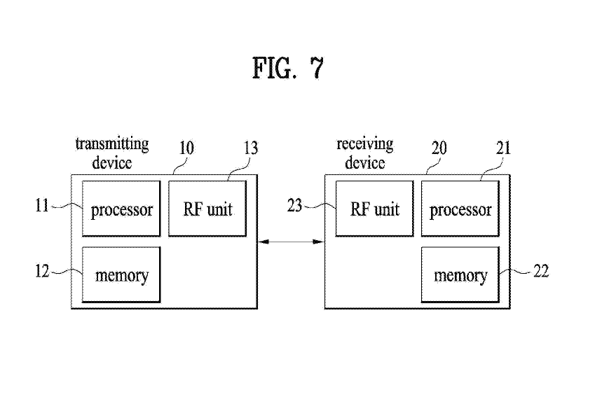

FIG. 6 is a diagram illustrating an operation according to one embodiment of the present invention.

FIG. 6 illustrates an operation for transmitting a sounding reference signal for positioning in a wireless communication system. The operation is performed by a terminal.

The terminal can receive power control related configuration information on a sounding reference signal [S610]. If a condition for using the power control related configuration information is satisfied, the terminal may transmit a sounding reference signal using the power control related configuration information [S620]. The power control related configuration information may indicate a sounding reference signal for the positioning-dedicated transmission power value or a transmission power control scheme.

The terminal may use the power control related configuration information when at least one of the followings occurs.
When transmission of the sounding reference signal is triggered by a predetermined triggering type, if the sounding reference signal is transmitted in a predetermined time resource or a predetermined frequency resource,
When a bit field indicating the predetermined triggering type corresponds to a predetermined bit value, or
When a mode of a feedback of uplink (UL) control information only via a UL data channel is configured and a predetermine bit field belonging to information indicating transmission of the UL control information corresponds to a predetermine bit value.

If a plurality of cells or component carriers are configured for the terminal, a condition for using the power control related configuration information may be independently configured according to each cell or each component carrier.

And, the sounding reference signal may be allocated to a UL resource using a sounding reference signal-dedicated resource allocation scheme. The resource allocation scheme may indicate allocation of a resource allocated to the last N symbols in a subframe in which the sounding reference signal is transmitted or allocation of a resource allocated to the last M symbols of each slot in a subframe in which the sounding reference signal is transmitted.

In the foregoing description, the embodiments according to the present invention have been briefly explained with reference to FIG. 6. Embodiments related to FIG. 6 can alternatively or additionally include at least a part of the aforementioned embodiment(s).

FIG. 7 is a block diagram illustrating a transmitter 10 and a receiver 20 configured to implement embodiments of the present invention. Each of the transmitter 10 and receiver 20 includes a radio frequency (RF) unit 13, 23 capable of transmitting or receiving a radio signal that carries information and/or data, a signal, a message, etc., a memory 12, 22 configured to store various kinds of information related to communication with a wireless communication system, and a processor 11, 21 operatively connected to elements such as the RF unit 13, 23 and the memory 12, 22 to control the memory 12, 22 and/or the RF unit 13, 23 to allow the device to implement at least one of the embodiments of the present invention described above.

The memory 12, 22 may store a program for processing and controlling the processor 11, 21, and temporarily store input/output information. The memory 12, 22 may also be utilized as a buffer. The processor 11, 21 controls overall operations of various modules in the transmitter or the receiver. Particularly, the processor 11, 21 may perform various control functions for implementation of the present invention. The processors 11 and 21 may be referred to as controllers, microcontrollers, microprocessors, microcomputers, or the like. The processors 11 and 21 may be achieved by hardware, firmware, software, or a combination thereof. In a hardware configuration for an embodiment of the present invention, the processor 11, 21 may be provided with application specific integrated circuits (ASICs) or digital signal processors (DSPs), digital signal processing devices (DSPDs), programmable logic devices (PLDs), and field programmable gate arrays (FPGAs) that are configured to implement the present invention. In the case which the present invention is implemented using firmware or software, the firmware or software may be provided with a module, a procedure, a function, or the like which performs the functions or operations of the present invention. The firmware or software configured to implement the present invention may be provided in the processor 11, 21 or stored in the memory 12, 22 to be driven by the processor 11, 21.

The processor 11 of the transmitter 10 performs predetermined coding and modulation of a signal and/or data scheduled by the processor 11 or a scheduler connected to the processor 11, and then transmits a signal and/or data to the RF unit 13. For example, the processor 11 converts a data sequence to be transmitted into K layers through demultiplexing and channel coding, scrambling, and modulation. The coded data sequence is referred to as a codeword, and is equivalent to a transport block which is a data block provided by the MAC layer. One transport block is coded as one codeword, and each codeword is transmitted to the receiver in the form of one or more layers. To perform frequency-up transformation, the RF unit 13 may include an oscillator. The RF unit 13 may include Nt transmit antennas (wherein Nt is a positive integer greater than or equal to 1).

The signal processing procedure in the receiver 20 is configured as a reverse procedure of the signal processing procedure in the transmitter 10. The RF unit 23 of the receiver 20 receives a radio signal transmitted from the transmitter 10 under control of the processor 21. The RF unit 23 may include Nr receive antennas, and retrieves baseband signals by frequency down-converting the signals received through the receive antennas. The RF unit 23 may include an oscillator to perform frequency down-converting. The processor 21 may perform decoding and demodulation on the radio signal received through the receive antennas, thereby retrieving data that the transmitter 10 has originally intended to transmit.

The RF unit 13, 23 includes one or more antennas. According to an embodiment of the present invention, the antennas function to transmit signals processed by the RF unit 13, 23 are to receive radio signals and deliver the same to the RF unit 13, 23. The antennas are also called antenna ports. Each antenna may correspond to one physical antenna or be configured by a combination of two or more physical antenna elements. A signal transmitted through each antenna cannot be decomposed by the receiver 20 anymore. A reference signal (RS) transmitted in accordance with a corresponding antenna defines an antenna from the perspective of the receiver 20, enables the receiver 20 to perform channel estimation on the antenna irrespective of whether the channel is a single radio channel from one physical antenna or a composite channel from a plurality of physical antenna elements including the antenna. That is, an antenna is defined such that a channel for delivering a symbol on the antenna is derived from a channel for delivering another symbol on the same antenna. An RF unit supporting the Multiple-Input Multiple-Output (MIMO) for transmitting and receiving data using a plurality of antennas may be connected to two or more antennas.

In embodiments of the present invention, the UE operates as the transmitter 10 on uplink, and operates as the receiver 20 on downlink. In embodiments of the present invention, the eNB operates as the receiver 20 on uplink, and operates as the transmitter 10 on downlink.

The transmitter and/or receiver may be implemented by one or more embodiments of the present invention among the embodiments described above.

Detailed descriptions of preferred embodiments of the present invention have been given to allow those skilled in the art to implement and practice the present invention. Although descriptions have been given of the preferred embodiments of the present invention, it will be apparent to those skilled in the art that various modifications and variations can be made in the present invention defined in the appended claims. Thus, the present invention is not intended to be limited to the embodiments described herein, but is intended to have the widest scope consistent with the principles and novel features disclosed herein.

### INDUSTRIAL APPLICABILITY

The present invention is applicable to wireless communication devices such as a terminal, a relay, and a base station.

What is claimed is:

1. A method of transmitting a sounding reference signal for positioning, which is transmitted by a terminal in a wireless communication system, comprising:
receiving power control related configuration information on a sounding reference signal; and
if a condition for using the power control related configuration information is satisfied, transmitting the sounding reference signal using the power control related configuration information,
wherein the power control related configuration information indicates a sounding reference signal for the positioning-dedicated transmission power value or a transmission power control scheme.

2. The method of claim 1, wherein the condition for using the power control related configuration information is satisfied when at least one of the followings occurs: when transmission of the sounding reference signal is triggered by a predetermined triggering type, when the sounding reference signal is transmitted in a predetermined time resource or a predetermined frequency resource, when a bit field indicating the predetermined triggering type corresponds to a predetermined bit value, and when a mode for a feedback of uplink (UL) control information only via a UL data channel is configured and a predetermined bit field belonging to information indicating transmission of the UL control information corresponds to a predetermined bit value.

3. The method of claim 1, wherein if a plurality of cells or component carriers are configured for the terminal, a condition for using the power control related configuration information is independently configured according to each cell or each component carrier of the configured plurality of cells or component carriers.

4. The method of claim 1, wherein the sounding reference signal is allocated to a UL resource using a resource allocation scheme dedicated to the sounding reference signal.

5. The method of claim 4, wherein the resource allocation scheme indicates allocation to the last N symbols in a subframe in which the sounding reference signal is transmitted or allocation to the last M symbols of each slot in the subframe in which the sounding reference signal is transmitted.

6. A terminal configured to transmit a sounding reference signal for positioning in a wireless communication system, comprising:
a radio frequency (RF) unit; and
a processor that controls the RF unit, wherein the processor controls the RF unit to receive power control related configuration information on a sounding reference signal, if a condition for using the power control related configuration information is satisfied, controls the RF unit to transmit the sounding reference signal using the power control related configuration information,
wherein the power control related configuration information indicates a sounding reference signal for the positioning-dedicated transmission power value or a transmission power control scheme.

7. The terminal of claim 6, wherein the condition for using the power control related configuration information is satisfied when at least one of the followings occurs: when transmission of the sounding reference signal is triggered by a predetermined triggering type, when the sounding reference signal is transmitted in a predetermined time resource or a predetermined frequency resource, when a bit field indicating the predetermined triggering type corresponds to a predetermined bit value, and when a mode for a feedback of uplink (UL) control information only via a UL data channel is configured and a predetermined bit field belonging to information indicating transmission of the UL control information corresponds to a predetermined bit value.

8. The terminal of claim 6, wherein if a plurality of cells or component carriers are configured for the terminal, a condition for using the power control related configuration information is independently configured according to each cell or each component carrier of the configured plurality of cells or component carriers.

9. The terminal of claim 6, wherein the sounding reference signal is allocated to a UL resource using a resource allocation scheme dedicated to the sounding reference signal.

10. The terminal of claim 9, wherein the resource allocation scheme indicates allocation to the last N symbols in a subframe in which the sounding reference signal is transmitted or allocation to the last M symbols of each slot in the subframe in which the sounding reference signal is transmitted.
